(19) United States
(12) Patent Application Publication
(10) Pub. No.: US 2019/0235622 A1
(43) Pub. Date: Aug. 1, 2019

(54) Augmented Reality Display Method and Head-Mounted Display Device

(71) Applicant: Huawei Technologies Co., Ltd., Shenzhen (CN)

(72) Inventors: Yongfeng Tu, Shenzhen (CN); Wenmei Gao, Beijing (CN)

(21) Appl. No.: 16/311,515

(22) PCT Filed: Jun. 20, 2016
(86) PCT No.: PCT/CN2016/086387

§ 371 Date: Dec. 19, 2018

(51) Int. Cl. G06F 3/01; G06K 9/00; G06F 3/16; G06F 3/0481

(52) U.S. Cl. CPC G06F 3/013; G06F 3/04815; G06F 3/167; G06K 9/00671

(57) ABSTRACT

An augmented reality display method based on three-dimensional reconstruction and location tracing, and a head-mounted display device, where a location of a user is determined based on the three-dimensional reconstruction and the location tracing. An object at which the user currently looks is determined according to a direction of a line of sight of the user in three-dimensional space. Further, augmented reality information of the object at which the user looks is displayed.

### TECHNICAL FIELD

The present invention relates to the communications field, and in particular, to an augmented reality display method based on three-dimensional reconstruction and location tracing, and a head-mounted display device.

### BACKGROUND

Augmented reality (AR) is a technology for enhancing a user's perception of the real world by using information provided by a computer system. AR superimposes a virtual object, a virtual scene, or system prompt information generated by a computer onto a real scene to enhance or modify perception of a real world environment or of data indicating a real world environment. For example, a sensing input device such as a camera or a microphone may be used to capture, in real time, data indicating the real world environment, and virtual data that is generated by the computer and includes a virtual image and a virtual sound is used to enhance the data. The virtual data may further include information about the real world environment, such as text descriptions associated with real world objects in the real world environment. Objects in an AR environment may include real objects (objects that exist in a specific real world environment) and virtual objects (objects that do not exist in the specific real world environment).

In the prior art, manners of triggering a virtual object presentation mainly include: triggering by recognizing an artificial marker, triggering by determining a target object through image recognition, and triggering based on location information. The conventional trigger manners are accompanied with problems such as additional settings of artificial markers, inaccurate image recognition, and inaccurate location information. Therefore, how to accurately recognize an object that requires augmented reality displaying is a technical problem to be resolved urgently in the industry.

### SUMMARY

In view of the foregoing technical problem, objectives of the present invention are to provide an augmented reality display method and a head-mounted display device to determine a location of a user based on three-dimensional reconstruction and location tracing, determine, according to a direction of a line of sight of the user in three-dimensional space, an object at which the user currently looks, and further display augmented reality information of the object at which the user looks.

The present invention may be applied to a public place with a relatively fixed layout and with a three-dimensional map maintained by a special person, for example, a botanical garden, a zoo, a theme park, an amusement park, a museum, an exhibition hall, a supermarket, a shop, a shopping mall, a hotel, a hospital, a bank, an airport, or a station.

According to a first aspect, a method is provided and applied to a head-mounted display device. The method includes: receiving a three-dimensional map of an area in which a user is located, where the three-dimensional map includes identification information of objects, and the identification information corresponds to augmented reality information of the objects; determining an object at which the user looks, where the object is a target to which a line of sight of the user points in the three-dimensional map; obtaining, from the three-dimensional map, identification information of the object at which the user looks; and displaying augmented reality information corresponding to the identification information of the object. According to the foregoing method, an object that requires augmented reality displaying can be recognized accurately, and augmented reality information of the object is displayed.

In a possible design, the determining an object at which the user looks includes: computing a location of the user in a three-dimensional scene of the area, a direction of the line of sight of the user in the three-dimensional scene, and a height of eyes of the user in the three-dimensional scene, and the three-dimensional scene is established by using a three-dimensional reconstruction technology and corresponds to the three-dimensional map. The location of the user and the direction of the line of sight of the user are determined, and therefore, the object that requires augmented reality displaying is recognized accurately.

In a possible design, the computing a direction of the line of sight of the user in the three-dimensional scene includes: computing an included angle a between the line of sight of the user and a due north direction and an included angle β between the line of sight of the user and a gravitational acceleration direction. The included angles a and β are determined, and therefore, the direction of the line of sight of the user in the three-dimensional scene is computed.

In a possible design, before the displaying augmented reality information, the object is verified by using an image recognition technology. Therefore, accuracy may be further improved.

In a possible design, before the obtaining identification information of the object, a voice instruction of the user is received, where the voice instruction is to obtain the identification information of the object or display the augmented reality information of the object. The operation of obtaining the identification information or displaying the augmented reality information is performed only when a definite voice instruction of the user is received. Therefore, it is ensured that the presented augmented reality information is content that the user expects to obtain.

In a possible design, before the obtaining identification information of the object, a dwell time of the line of sight of the user on the object exceeds a predetermined value. Therefore, augmented reality information of an object that the user is interested in may be presented.

According to a second aspect, a head-mounted display device is provided, where the head-mounted display device includes units configured to perform the method according to any one of the first aspect or possible implementations of the first aspect.

According to a third aspect, a computer readable storage medium storing one or more programs is provided, where the one or more programs include an instruction, and when the instruction is executed by a head-mounted display device, the head-mounted display device performs the method according to any one of the first aspect or possible implementations of the first aspect.

According to a fourth aspect, a head-mounted display device is provided, where the head-mounted display device may include one or more processors, a memory, a display, a bus system, a transceiver, and one or more programs, where the processor, the memory, the display, and the transceiver are connected by the bus system, where the one or more programs are stored in the memory, the one or more programs include an instruction, and when the instruction is executed by the head-mounted display device, the head-mounted display device performs the method according to any one of the first aspect or possible implementations of the first aspect.

According to a fifth aspect, a graphical user interface on a head-mounted display device is provided, where the head-mounted display device includes a memory, multiple application programs, and one or more processors configured to execute one or more programs stored in the memory, and the graphical user interface includes a user interface displayed in the method according to any one of the first aspect or possible implementations of the first aspect.

Optionally, the following possible designs may be combined with the first aspect to the fifth aspect of the present invention.

In a possible design, an eyeball tracing technology is used to determine an object at which the user looks. This may make a process of determining an object more accurate.

In a possible design, an included angle 01 between a horizontal axis of the head-mounted display device and a connection line that connects a line-of-sight focus of eyes of the user to a center of left and right eyes, and an included angle 02 between a vertical axis of the head-mounted display device and the connection line are determined. Therefore, a more accurate direction of the line of sight of the user may be obtained.

According to the foregoing technical solutions, an object that requires augmented reality displaying can be recognized accurately, and augmented reality information of the object is displayed.

### BRIEF DESCRIPTION OF DRAWINGS

FIG. 1 is a schematic diagram of a possible application scenario according to the present invention;

FIG. 2 is a schematic diagram of displaying augmented reality information in a head-mounted display device according to the present invention;

FIG. 3 is a schematic diagram of a head-mounted display device according to the present invention; and

FIG. 4 is a flowchart of a method for displaying augmented reality information according to the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. The following descriptions are merely examples of embodiments of the present invention, but are not intended to limit the present invention. Any modification, equivalent replacement, or improvement made without departing from the spirit and principle of the present invention should fall within the protection scope of the present invention.

It should be understood that, ordinal numbers such as “first” and “second”, when mentioned in the embodiments of the present invention, are used only for distinguishing, unless the ordinal numbers definitely represent an order according to the context.

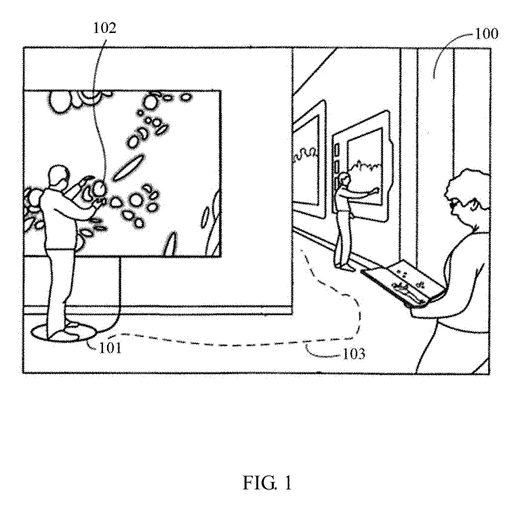

FIG. 1 shows a possible application scenario of a head-mounted display device according to the present invention.

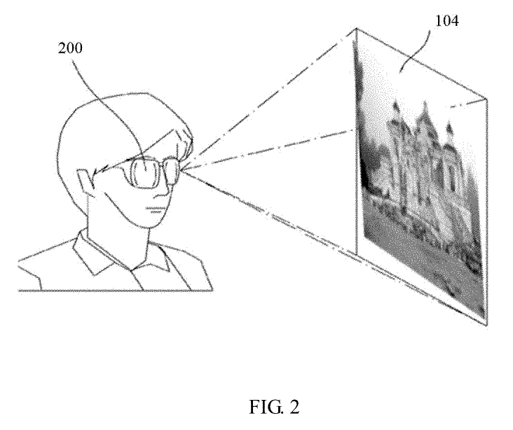

When a user wearing a head-mounted display device 200 (as shown in FIG. 2) enters an area 100, the user receives a three-dimensional map of the area 100. The area 100 represents a place with a relatively fixed layout and with a three-dimensional map maintained by a special person. The place includes but is not limited to a botanical garden, a zoo, a theme park, an amusement park, a museum, an exhibition hall, a supermarket, a shop, a shopping mall, a hotel, a hospital, a bank, an airport, a station, or the like.

The user may move along a path 103 in the area 100, and dwells in a location 101 at a special time. In the location 101, the user may obtain augmented reality information 104 of an object 102 (as shown in FIG. 2).

The path 103 represents only a moving route of the user. A start point, an end point, and an intermediate point of the moving route are not limited.

When detecting that the user enters the area 100, the head-mounted display device 200 (also referred to as an HMD 200 hereinafter) may automatically receive the three-dimensional map of the area. Optionally, the head-mounted display device 200 may preload the three-dimensional map of the area. In this case, the head-mounted display device 200 corresponds to one or several areas 100. The head-mounted display device 200 may be provided for and used by the user that enters the area 100, and taken back when the user leaves the area 100. Optionally, the head-mounted display device 200 may also ask the user whether to receive the three-dimensional map of the area 100, and receive the three-dimensional map only when the user confirms to receive the three-dimensional map.

The three-dimensional map of the area 100 is created in advance by a manager of the area 100, and the three-dimensional map may be stored in a server for the head-mounted display device 200 to download, or the three-dimensional map may be stored in the head-mounted display device. Creation of the three-dimensional map may be implemented by using a conventional simultaneous localization and mapping (English full name:

Simultaneous localization and mapping, SLAM for short) technology, and another technology well known to a person skilled in the art. The SLAM technology may allow the HMD 200 to depart from an unknown place of an unknown environment, determine a location and a posture of the HMD 200 by using features (for example, a corner of a wall and a pillar) of the map that are observed repeatedly in the moving process, and incrementally create the map according to the location of the HMD 200, thereby achieving an objective of simultaneous localization and mapping. In the SLAM technology, the device scans the environment comprehensively by using a depth camera or a laser radar (LiDAR), and performs three-dimensional reconstruction on the whole area and objects in the area to obtain three-dimensional coordinate information of a real world in the area.

The three-dimensional map in the present invention includes identification information of the object 102, and the identification information corresponds to the augmented reality information of the object 102. The object 102 represents an augmented reality object in the area 100, and the augmented reality object is an object that has augmented reality information.

The augmented reality information may be one or any combination of a text, a picture, an audio, a video, or a three-dimensional virtual object. The three-dimensional virtual object includes at least one of a fictional character or a virtual object, and a status of the three-dimensional virtual object may be static or dynamic. The augmented reality information and the three-dimensional map may be stored separately. The augmented reality information may also be included as a part of the three-dimensional map in the three-dimensional map.

The HMD 200 determines the object 102 at which the user looks in the area 100. The object 102 is a target to which a line of sight of the user points in the three-dimensional map. Afterward, the HMD 200 obtains the identification information of the object 102 from the three-dimensional map, and provides the user with the augmented reality information corresponding to the identification information.

A specific method for determining the object 102 at which the user looks in the area 100 is hereinafter described in detail.

FIG. 2 shows a schematic diagram of displaying augmented reality information in a head-mounted display device according to the present invention.

The head-mounted display device 200 disclosed according to the present invention may use any appropriate form, including but not limited to a form of glasses shown in FIG. 2. For example, the head-mounted display device may also be a single-eye device, or have a head-mounted helmet structure.

The head-mounted display device 200 disclosed according to the present invention may be a device that has a strong independent computing capability and large-capacity storage space, and therefore may work independently, that is, the head-mounted display device does not need to be connected to a mobile phone or another terminal device. The head-mounted display device 200 may also be connected to a mobile phone or another terminal device in a wireless connection mode, and implement functions of the present invention by using a computing capability and storage space of the mobile phone or another terminal device. The head-mounted display device 200 may be connected to the mobile phone or another terminal device in a wireless mode well known to a person skilled in the art, for example, through Wi-Fi or Bluetooth.

As shown in FIG. 2, the user may see the augmented reality information 104 of the object 102 in FIG. 1 by using the HMD 200. The object 102 is a photo of Ruins of the Old Summer Palace, and the augmented reality information 104 of the object 102 is an original look of the Old Summer Palace before destroy.

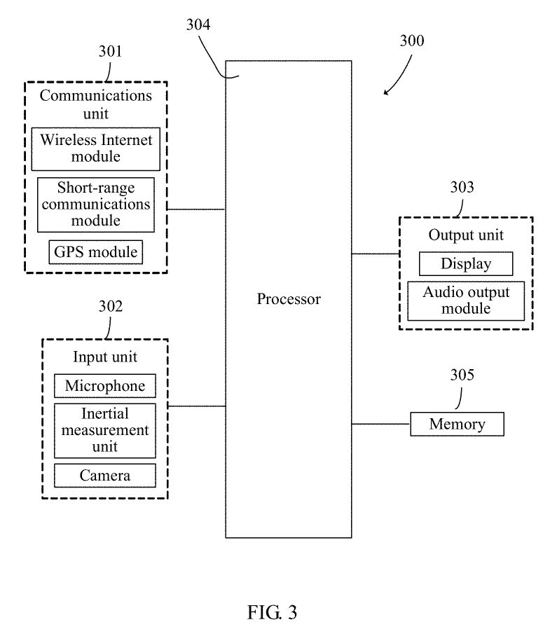

FIG. 3 is a schematic block diagram for describing a head-mounted display device 300.

As shown in FIG. 3, the head-mounted display device 300 includes a communications unit 301, an input unit 302, an output unit 303, a processor 304, a memory 305, and the like. FIG. 3 shows the head-mounted display device 300 having various components. However, it should be understood that, an implementation of the head-mounted display device 300 does not necessarily require all the components shown in the figure. The head-mounted display device 300 may be implemented by using more or fewer components.

The following explains each of the foregoing components.

The communications unit 301 generally includes one or more components. The component allows wireless communication between multiple head-mounted display devices 300 and wireless communication between the head-mounted display device 300 and a wireless communications system.

The head-mounted display device 300 may communicate, by using the communications unit 301, with a server storing a three-dimensional map. As described above, when augmented reality information and the three-dimensional map are stored separately, the server includes a three-dimensional map database and an augmented reality information database.

The communications unit 301 may include at least one of a wireless Internet module or a short-range communications module.

The wireless Internet module provides support for wireless Internet access for the head-mounted display device 300. Herein, as a wireless Internet technology, a wireless local area network (WLAN), Wi-Fi, wireless broadband (WiBro), Worldwide Interoperability for Microwave Access (WiMax), High Speed Downlink Packet Access (HSDPA), or the like may be used.

The short-range communications module is a module configured to support short-range communication. Examples of short-range communications technologies may include Bluetooth (Bluetooth), radio frequency identification (RFID), the Infrared Data Association (IrDA), ultra-wideband (UWB), ZigBee (ZigBee), D2D (Device-to-Device), and the like.

The communications unit 301 may further include a GPS (global positioning system) module. The GPS module receives radio waves from multiple GPS satellites (not shown) on the earth's orbit, and may compute a location of the head-mounted display device 300 by using an arrival time of the radio waves from the GPS satellites at the head-mounted display device 300.

The communications unit 301 may include a receiving unit, configured to receive a three-dimensional map of an area 100 in which a user is located. The receiving unit may be configured as a part of the communications unit 301 or as an independent component.

The input unit 302 is configured to receive an audio or video signal. The input unit 302 may include a microphone, an inertial measurement unit (IMU), and a camera.

The microphone may receive a sound corresponding to a voice instruction of the user and/or an ambient sound generated in an environment of the head-mounted display device 300, and process a received sound signal into electrical voice data. The microphone may use any one of various denoising algorithms to remove noise generated when an external sound signal is received.

The inertial measurement unit (IMU) is configured to sense a location, a direction, and an acceleration (pitching, rolling, and yawing) of the head-mounted display device 300, and determine a relative position relationship between the head-mounted display device 300 and an object 102 in the area 100 through computation. When the user wearing the head-mounted display device 300 uses the system for the first time, parameters related to a stature of the user may be input, so that a height of a head of the user is determined. After three-dimensional coordinates x, y, and z of the location of the head-mounted display device 300 in the area 100 are determined, the height of the head of the user that wears the head-mounted display device 300 may be determined through computation, and a direction of a line of sight of the user may be determined. The inertial measurement unit includes an inertial sensor, such as a tri-axis magnetometer, a tri-axis gyroscope, and a tri-axis accelerometer.

The camera processes, in a video capture mode or an image capture mode, image data of a video or a still image obtained by an image capture apparatus, and further obtains image information of a background scene and/or physical space viewed by the user. The image information of the background scene and/or the physical space includes the object 102 in the area 100. The camera optionally includes a depth camera and an RGB camera (also referred to as a color camera).

The depth camera is configured to capture a depth image information sequence of the background scene and/or the physical space, and construct a three-dimensional model of the background scene and/or the physical space. The depth image information may be obtained by using any appropriate technology, including but not limited to a time of flight, structured light, and a three-dimensional image. Depending on a technology used in depth sensing, the depth camera may require additional components (for example, an infrared emitter needs to be disposed when the depth camera detects an infrared structured light pattern), although the additional components may not be in a same position as the depth camera.

The RGB camera (also referred to as a color camera) is configured to capture the image information sequence of the background scene and/or the physical space at a visible light frequency.

According to configurations of the head-mounted display device 300, two or more depth cameras and/or RGB cameras may be provided. The RGB camera may use a fisheye lens with a wide field of view.

The output unit 303 is configured to provide an output (for example, an audio signal, a video signal, an alarm signal, or a vibration signal) in a visual, audible, and/or tactile manner. The output unit 303 may include a display and an audio output module.

As shown in FIG. 2, the display includes lenses forming glasses, so that augmented reality information may be displayed through the lenses (for example, through projection on the lenses, through a waveguide system included in the lenses, and/or in any other appropriate manner). Either of the lenses may be fully transparent to allow the user to perform viewing through the lens. When an image is displayed in a projection manner, the display may further include a micro projector not shown in FIG. 3. The micro projector is used as an input light source of an optical waveguide lens and provides a light source for displaying content. The display outputs an image signal related to a function performed by the head-mounted display device 300, for example, the foregoing augmented reality information 104.

The audio output module outputs audio data that is received from the communications unit or stored in the memory 305. The audio data may be augmented reality information in an audio format. In addition, the audio output module outputs a sound signal related to a function performed by the head-mounted display device 300, for example, a voice instruction receiving sound or a notification sound. The audio output module may include a speaker, a receiver, or a buzzer.

The processor 304 may control overall operations of the head-mounted display device 300, and perform control and processing associated with displaying augmented reality information, determining an object at which the user looks, voice interaction, and the like. The processor 304 may receive and interpret an input from the input unit 302, perform voice recognition processing, compare a voice instruction received through the microphone with a voice instruction stored in the memory 305, and determine a specific operation that the user expects the head-mounted display device 300 to perform. The user may instruct, by using the voice instruction, the head-mounted display device 300 to obtain identification information or display augmented reality information.

The processor 304 may include a computation unit and a determining unit not shown in the figure. After receiving the three-dimensional map of the area 100, the head-mounted display device 300 performs real-time three-dimensional reconstruction on a current environment of the user by using the camera, and establishes a three-dimensional scene of the user in the area 100. The three-dimensional scene has a three-dimensional coordinate system, and the established three-dimensional scene corresponds to the received three-dimensional map. The computation unit computes a location 101 of the user in the three-dimensional scene of the area 100, a direction of the line of sight of the user in the three-dimensional scene, and a height of eyes of the user in the three-dimensional scene. The determining unit determines, according to a computation result of the computation unit, a first object that the line of sight of the user intersects in the three-dimensional coordinate system of the three-dimensional scene, as the object 102 at which the user looks.

The inertial measurement unit (IMU) may be used to trace a moving path 103 of the user. The location 101 of the user in the three-dimensional scene is determined through computation based on the three-dimensional scene and a tracing result of the IMU.

The processor 304 may further include an obtaining unit not shown in the figure. The obtaining unit is configured to obtain, according to coordinates of the object 102 in the three-dimensional coordinate system, identification information of the object 102 from the three-dimensional map corresponding to the three-dimensional scene.

The processor 304 may further include a verification unit not shown in the figure. The verification unit is configured to verify, by using an image recognition technology, the object 102 at which the user looks, and verify whether the object 102 determined by the determining unit is consistent with an image recognition result, so as to further improve accuracy.

The computation unit, the determining unit, the obtaining unit, and the verification unit may be configured as a part of the processor 304 or as independent components.

The memory 305 may store a software program executed by the processor 304 to process and control operations, and may store input or output data, for example, the three-dimensional map of the area 100, the identification information of the object, augmented reality information corresponding to the identification information, and a voice instruction. In addition, the memory 305 may further store data related to an output signal of the output unit 303.

An appropriate storage medium of any type may be used to implement the memory. The storage medium includes a flash memory, a hard disk, a micro multimedia card, a memory card (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In addition, the head-mounted display device 300 may perform operations related to a network storage apparatus that performs a storage function of a memory on the Internet.

The head-mounted display device 300 may further include an eyeball tracing unit, an interface unit, and a power supply unit.

The eyeball tracing unit may include an infrared light source and an infrared camera. The infrared light source emits infrared light to the eyes of the user. The infrared camera receives the infrared light reflected by pupils of eyeballs of the user, and provides line-of-sight location information of the eyeballs. The infrared camera may be a pinhole infrared camera. The infrared light source may be an infrared emitting diode or an infrared laser diode. A more accurate direction of the line of sight of the user may be obtained by using the eyeball tracing unit.

The interface unit may be generally implemented to connect the head-mounted display device 300 to an external device. The interface unit may allow receiving data from the external device, and transmit electric power to each component of the head-mounted display device 300, or transmit data from the head-mounted display device 300 to the external device. For example, the interface unit may include a wired/wireless headphone port, an external charger port, a wired/wireless data port, a memory card port, an audio input/output (I/O) port, a video I/O port, or the like.

The power supply unit is configured to supply electric power to each component of the head-mounted display device 300, so that the head-mounted display device 300 can perform an operation. The power supply unit may include a charge battery, a cable, or a cable port. The power supply unit may be disposed in each position on a framework of the head-mounted display device.

The foregoing components of the head-mounted display device 300 may be mutually coupled by using any one or any combination of buses such as a data bus, an address bus, a control bus, an extended bus, or a local bus.

Each implementation described in the specification may be implemented in a computer readable medium or another similar medium by using software, hardware, or any combination thereof.

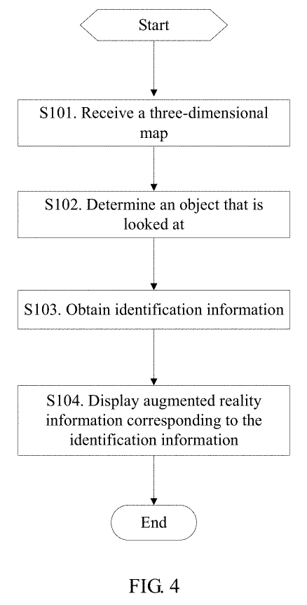

FIG. 4 is a flowchart of a method for displaying augmented reality information according to the present invention.

Step S101: A head-mounted display device receives a three-dimensional map of an area in which a user is located, where the three-dimensional map includes three-dimensional location information of all objects in the area and identification information of the objects, and the identification information corresponds to augmented reality information of the objects. As described above, the head-mounted display device may automatically receive the three-dimensional map from a server, or may prestore the three-dimensional map in the head-mounted display device, or receive the three-dimensional map only when a user confirms. An address of the server used for receiving the three-dimensional map may be prestored in the head-mounted display device, or may be obtained by barcode scanning when a specific area is entered.

The following uses an example to describe three-dimensional location information of an object in three-dimensional space. When a three-dimensional model is used to describe the object, generally, a group of polygons of surfaces enclosing an interior of the object are used for description. If there are more polygons, descriptions about the object are more accurate. When the object is described by using a triangular pyramid, a triangular pyramid model of the object is shown in the following Table 1, where coordinates of vertices V1 to V4 are three-dimensional coordinates in the three-dimensional map.

TABLE 1

| Vertex table | Edge table | Surface table |
|---|---|---|
| (vertex table) | (edge table) | (surface table) |
| V1: x1, y1, z1 | E1: V1, V2 | S1: E1, E2, E3 |
| V2: x2, y2, z2 | E2: V2, V3 | S2: E3, E4, E5 |
| V3: x3, y3, z3 | E3: V1, V3 | S3: E1, E5, E6 |
| V4: x4, y4, z4 | E4: V3, V4 | S4: E2, E4, E6 |
| | E5: V1, V4 | |
| | E6: V2, V4 | |

Step S102: Determine an object at which the user looks, where the object is a target to which a line of sight of the user points in the three-dimensional map.

In step S102, the head-mounted display device starts environment three-dimensional reconstruction and track and posture tracing functions. As the user moves, the head-mounted display device performs real-time reconstruction on an environment and objects in a current field of view by using a depth camera and an RGB camera, performs feature matching between a reconstructed three-dimensional scene and the three-dimensional map that is already loaded, and determines a current approximate location. In addition, an inertial measurement unit performs real-time tracing on a moving track of the user, and performs drift correction continuously with reference to a determined approximate location. Therefore, an accurate moving track that is superimposed in the three-dimensional map is obtained, and a real-time precise location (Xuser, Yuser, Zuser) of the user is determined.

The inertial measurement unit computes a motion track of a head of the user in real time, and therefore, and obtains a direction of a current line of sight of the user in the three-dimensional scene. The direction includes an included angle a between the line of sight of the user and a due north direction and an included angle β between the line of sight of the user and a gravitational acceleration direction.

The inertial measurement unit may further determine a real-time height Huser of eyes of the user from the ground in the three-dimensional scene. An initial height is input by the user beforehand, and a subsequent real-time height is obtained by the inertial measurement unit through tracing and computation.

Based on the foregoing determined four parameters: {location (Xuser, Yuser, Zuser) of the user in the three-dimensional scene, the included angle a between the current line of sight of the user and the due north direction, the included angle β between the current line of sight of the user and the gravitational acceleration direction}, a mathematical equation of the line of sight of the user in the three-dimensional scene may be obtained through computation.

To obtain a more accurate direction of the line of sight of the user, an eyeball tracing unit in the head-mounted display device may be further used to determine an included angle θ1 between a horizontal axis of the head-mounted display device and a connection line that connects a line-of-sight focus of the eyes of the user to a center of left and right eyes and an included angle θ2 between a vertical axis of the head-mounted display device and the connection line.

According to the mathematical equation of the line of sight of the user in the three-dimensional scene and the direction of the line of sight of the user, a first object that the line of sight of the user intersects in a three-dimensional coordinate system of the three-dimensional scene may be determined as the object at which the user looks.

Step S103: Obtain, from the three-dimensional map, identification information of the object at which the user looks.

The object at which the user looks in the three-dimensional map is mapped to the three-dimensional map, and the identification information of the object is obtained from the three-dimensional map.

Before step S103, the foregoing RGB camera may be further used to perform image recognition on the object at which the user looks, compare an image recognition result with the object determined in step S102, and verify whether the object 102 determined in step S102 is consistent with the image recognition result, so that accuracy is further improved. After the verification succeeds, an operation of obtaining identification information or an operation of displaying augmented reality information may be started. If the object 102 determined in step S102 is inconsistent with the image recognition result, the user may be prompted to select and confirm identification information and augmented reality information of a specific object that the user expects to obtain.

Before step S103, the foregoing microphone may be further used to receive a voice instruction of the user, where the voice instruction is to obtain the identification information of the object 102 or display the augmented reality information of the object 102. The operation of obtaining the identification information is performed only when a definite voice instruction of the user is received. Therefore, it may be ensured that only content that the user is interested in is obtained.

Before step S103, a dwell time of the line of sight of the user on the object 102 may be further detected, and the operation of obtaining the identification information is performed only when the dwell time exceeds a predetermined value.

Step S104: Render and present augmented reality information, and display the augmented reality information corresponding to the identification information, where the augmented reality information may be one or any combination of a text, a picture, an audio, a video, or a three-dimensional virtual object. The three-dimensional virtual object includes at least one of a fictional character or a virtual object, and a status of the three-dimensional virtual object may be static or dynamic.

The augmented reality information is displayed near the object 102 in the display, or the displayed augmented reality information may be superimposed on the object 102.

Optionally, before step S104, the foregoing microphone may be further used to receive a voice instruction of the user, where the voice instruction is to display the augmented reality information of the object. The operation of displaying the augmented reality information is performed only when a definite voice instruction of the user is received.

Optionally, the foregoing operation of verifying the object by using the image recognition technology may be performed between steps S103 and S104.

Optionally, the foregoing operation of detecting the dwell time of the line of sight of the user on the object 102 may also be performed between steps S103 and S104, and the operation of displaying the augmented reality information is performed only when the dwell time exceeds the predetermined value.

Optionally, before step S101, when the user wearing the head-mounted display device enters a specific area 100 that has an AR service, the head-mounted display device first determines, based on current location information, that the current area has an AR service, and asks the user whether to enable an identification information obtaining function. The current location information may be obtained in a manner of GPS positioning, base station positioning, Wi-Fi positioning, or the like. The head-mounted display device may also directly enable the identification information obtaining function according to a presetting of the user without asking the user.

In the described solution to displaying augmented reality information in the present invention, positioning is performed based on machine vision and inertial navigation manners; with help of sensor data of an inertial measurement unit, and by using a solid geometry and a trigonometric function method, a location and a direction of a face of a user in a three-dimensional coordinate system of a real scene may be obtained, and therefore, an object to be recognized is determined. Further, corresponding augmented reality information is obtained, and is presented to the user in a most appropriate manner. This brings greatest convenience to the user.

According to the foregoing solution disclosed by the present invention, disadvantages such as inaccuracy and instability in determining an AR target based on an image recognition technology may be overcome. When a part of the object at which the user looks is blocked by another object, the object at which the user looks may also be determined accurately.

Method steps described in combination with the content disclosed in the present invention may be implemented by hardware, or may be implemented by a processor by executing a software instruction. The software instruction may be formed by a corresponding software module. The software module may be located in a RAM memory, a flash memory, a ROM memory, an EPROM memory, an EEPROM memory, a register, a hard disk, a removable magnetic disk, a CD-ROM, or a storage medium of any other form known in the art. For example, a storage medium is coupled to a processor, so that the processor can read information from the storage medium or write information into the storage medium. Certainly, the storage medium may be a component of the processor. The processor and the storage medium may be located in the ASIC. In addition, the ASIC may be located in user equipment. Certainly, the processor and the storage medium may exist in the user equipment as discrete components.

The objectives, technical solutions, and benefits of the present invention are further described in detail in the foregoing specific embodiments. It should be understood that the foregoing descriptions are merely specific embodiments of the present invention, but are not intended to limit the protection scope of the present invention. Any modification, equivalent replacement, or improvement made within the spirit and principle of the present invention shall fall within the protection scope of the present invention.

1. A method, applied to a head-mounted display device, wherein and the method comprising:
receiving a three-dimensional map of an area in which a user is located, wherein the three-dimensional map comprising identification information of objects, and the identification information corresponding to augmented reality information of the objects;
determining an object at which the user looks, the object being a target to which a line of sight of the user points in the three-dimensional map;
obtaining, from the three-dimensional map, identification information of the object at which the user looks; and
displaying augmented reality information corresponding to the identification information of the object.

2. The method of claim 1, wherein determining the object at which the user looks comprises computing a location of the user in a three-dimensional scene of the area, a direction of the fine of sight of the user in the three-dimensional scene, and a height of eyes of the user in the three-dimensional scene, and the three-dimensional scene being established using a three-dimensional reconstruction technology and corresponding to the three-dimensional map.

3. The method of claim 2, wherein computing the direction of the line of sight of the user in the three-dimensional scene comprises: computing an included angle between the line of sight of the user and a due north direction (α) and an included angle between the line of sight of the user and a gravitational acceleration direction (β).

4. The method of claim 1, wherein before displaying the augmented reality information, the method further comprises verifying the object using an image recognition technology.

5. The method of claim 1, wherein before obtaining the identification information of the object, the method further comprises receiving a voice instruction of the user, and the voice instruction being used to obtain the identification information of the object.

6. The method of claim 1, wherein before obtaining the identification information of the object, the method further comprises determining whether a dwell time of the line of sight of the user on the object exceeds a predetermined value.

7.-14. (canceled)

15. A graphical user interface on a head-mounted display device, the head-mounted display device comprising a memory, a plurality of application programs, and one or more processors configured to execute one or more programs stored in the memory, the graphical user interface comprising a user interface and the user interface being configured to:
receive a three-dimensional map of an area in which a user is located, the three-dimensional map comprising identification information of objects and the identification information corresponding to augmented reality information of the objects;
determine an object at which the user looks, the object being a target to which a line of sight of the user points in the three-dimensional map;
obtain, from the three-dimensional map, identification information of the object at which the user looks; and
display augmented reality information corresponding to the identification information of the object.

16. The graphical user interface of claim 15, wherein in a manner of determining the object at which the user looks, the user interface is further configured to compute a location of the user in a three-dimensional scene of the area, a direction of the line of sight of the user in the three-dimensional scene, and a height of eyes of the user in the three-dimensional scene, and the three-dimensional scene being established using a three-dimensional reconstruction technology and corresponding to the three-dimensional map.

17. The graphical user interlace of claim 16, wherein in a manner of computing the direction of the line of sight of the user in the three-dimensional scene, the user interface is further configured to compute an included angle between the line of sight of the user and a due north direction (α) and an included angle between the line of sight of the user and a gravitational acceleration direction (β).

18. The graphical user interface of claim 15, wherein before displaying the augmented reality information, the user interface is further configured to verify the object using an image recognition technology.

19. The method of claim 1, wherein before obtaining the identification information of the object, the method further comprises receiving a voice instruction of the user, and the voice instruction being used to display the augmented reality information of the object.

20. The method of claim 2, wherein before displaying the augmented reality information, the method further comprises verifying the object using an image recognition technology.

21. The method of claim 3, wherein before displaying the augmented reality information, the method further comprises verifying the object using an image recognition technology.

22. A head-mounted display device, comprising:
a memory comprising instructions; and
a processor coupled to the memory, the instructions causing the processor to cause the head-mounted display device to be configured to:
receive a three-dimensional map of an area in which a user is located, the three-dimensional map comprising identification information of objects, and the identification information corresponding to augmented reality information of the objects;
determine an object at which the user looks, the object being a target to which a line of sight of the user points in the three-dimensional map;
obtain, from the three-dimensional map, identification information of the object at which the user looks; and
display augmented reality information corresponding to the identification information of the object.

23. The head-mounted display device of claim 22, wherein the instructions further cause the head-mounted display device to compute a location of the user in a three-dimensional scene of the area, a direction of the line of sight of the user in the three-dimensional scene, and a height of eyes of the user in the three-dimensional scene, and the three-dimensional scene being established using a three-dimensional reconstruction technology and corresponding to the three-dimensional map.

24. The head-mounted display device of claim 23, wherein the instructions further cause the head-mounted display device to compute an included angle between the line of sight of the user and a due north direction (α) and an included angle between the line of sight of the user and a gravitational acceleration direction (β).

25. The head-mounted display device of claim 22, wherein the instructions further cause the head-mounted display device to verify the object using an image recognition technology.

26. The head-mounted display device of claim 22, wherein the instructions further cause the head-mounted display device to receive a voice instruction of the user, and the voice instruction being used to obtain the identification information of the object.

27. The head-mounted display device of claim 22, wherein the instructions further cause the head-mounted display device to receive a voice instruction of the user, and the voice instruction being used to display the augmented reality information of the object.

28. The head-mounted display device of claim 22, wherein the instructions further cause the head-mounted display device to determine whether a dwell time of the line of sight of the user on the object exceeds a predetermined value.
